(19) United States
(12) Patent Application Publication
(10) Pub. No.: US 2014/0204022 A1
(43) Pub. Date: Jul. 24, 2014

(54) METHOD OF OPERATING ELECTRONIC DISPLAY DEVICE AND ELECTRONIC DISPLAY DEVICE

(71) Applicant: SAMSUNG ELECTRONICS CO., LTD., Suwon-si (KR)

(72) Inventors: Monil PARMAR, Noida (IN); Manish CHHABRA, Noida (IN); Rahul TYAGI, Noida (IN)

(73) Assignee: SAMSUNG ELECTRONICS CO., LTD., Suwon-si (KR)

(21) Appl. No.: 14/160,740

(22) Filed: Jan. 22, 2014

(30) Foreign Application Priority Data
Jan. 21, 2013 (IN) 255/CHE/2013
Dec. 5, 2013 (KR) 10-2013-0150724

(51) Int. Cl. G06F 3/01

(52) U.S. Cl. CPC G06F 3/01
USPC 345/156

(57) ABSTRACT

A method for operating an electronic display device and the electronic display device are provided. The method may include configuring a plurality of modules of the electronic display device into a stand-by mode, receiving an input corresponding to a feature selected from among a plurality of features of the electronic display device, and initializing, from among the plurality of modules, one or more modules that correspond to the feature selected of the electronic display device, wherein one or more of the plurality of modules respectively correspond to one or more of the plurality of features.

### RELATED APPLICATIONS

This application claims priority from Indian Patent Application No. 255/CHE/2013, filed on Jan. 21, 2013, in the Indian Patent Office and Korean Patent Application No. 10-2013-0150724, filed on Dec. 5, 2013, in the Korean Intellectual Property Office, the disclosures of which are incorporated herein by reference in their entireties.

### BACKGROUND

1. Field

Methods and apparatuses consistent with exemplary embodiments relate to an electronic display device field, and more particularly, to a method of operating an electronic display device and the electronic display device.

2. Description of the Related Art

Electronic devices are widely used to view different form of digital content. The electronic devices may include, for example, televisions (TVs), mobile devices, and personal computers (PCs) but are not limited thereto. Such electronic devices may provide many additional features over and above the core features that provide the electronic devices' primary functionality. For example, a digital TV (DTV) not only plays a video stream provided by a broadcasting station but may also provide different features, e.g., web browsing, reproduction of multimedia from a universal serial bus (USB), and the like. However, in order to access any one of the features, it is recommended that a user wait through a full booting sequence of the DTV. For example, to open a web browser for checking an email, the user powers-on, or directs an input toward, the DTV which initializes each module of the DTV, then selects a main menu or a designated menu, and finally opens the web browser. Furthermore, a web browser application may have nothing to do with a tuner module or a video decoder module which was initialized. Accordingly, a booting time of the DTV may increase, power consumption may increase, and the performance of the DTV may decrease.

In consideration of the above discussion, there are demands for an efficient method and system for using an electronic display device as a multi-mode device.

### SUMMARY

According to an aspect of an exemplary embodiment, there is provided a method of operating an electronic display device, the method including configuring a plurality of modules of the electronic display device into a stand-by mode, receiving an input corresponding to a feature selected from among a plurality of features of the electronic display device, and initializing, from among the plurality of modules, one or more modules that correspond to the feature selected of the electronic display device, wherein one or more of the plurality of modules respectively correspond to one or more of the plurality of features.

The method may further include activating a display of the electronic display device in response to the input being received.

The method may further include providing, at the electronic display device, a plurality of buttons respectively corresponding to the plurality of features, wherein the plurality of buttons are configured to receive the input.

The method may further include providing, to an input device that is separate from the electronic display device, a plurality of buttons respectively corresponding to the plurality of features, wherein the plurality of buttons are configured to receive the input.

According to an aspect of another exemplary embodiment, there is provided an electronic display device including a display, a communication device configured to communicate with an input device, a memory configured to store instructions, and a processor configured to access the instructions stored in the memory, receive an input corresponding to a feature selected from among a plurality of features of the electronic display device, while the electronic display device is in a stand-by mode in response to the processor accessing the instructions, and initialize, from among a plurality of modules, one or more modules that correspond to the feature selected of the electronic display device, wherein one or more of the plurality of modules respectively correspond to one or more of the plurality of features.

The processor may activate the display of the electronic display device in response to the input being received and to accessing the instructions.

A plurality of buttons respectively corresponding to the plurality of features may be provided to the electronic display device, wherein the plurality of buttons are configured to receive the input.

The electronic display device may further including an input device that provides a plurality of buttons respectively corresponding to the plurality of features, wherein the plurality of buttons are configured to receive the input.

According to an aspect of another exemplary embodiment, there is provided a non-transitory computer-readable storage medium having stored therein program instructions, that when executed by a computer, perform a method of operating an electronic display device, the method including configuring a plurality of modules of the electronic display device into a stand-by mode, receiving an input corresponding to a feature selected from among a plurality of features of the electronic display device, and initializing, from among the plurality of modules, one or more modules that correspond to the feature selected of the electronic display device, wherein one or more of the plurality of modules respectively correspond to one or more of the plurality of features.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of an environment to which an exemplary embodiment may be applied;

FIG. 2 is a block diagram of an electronic display device according to an exemplary embodiment;

FIG. 3 is a block diagram of a processor in the electronic display device of FIG. 2, according to an exemplary embodiment;

FIG. 4 is a flowchart of a method of operating an electronic display device, according to an exemplary embodiment;

FIG. 5 illustrates a form in which an input is provided in an electronic display device, according to an exemplary embodiment;

FIG. 6 illustrates a form in which feature buttons are provided in an input device that is separated from an electronic display device, according to another exemplary embodiment;

FIG. 7 is a flowchart of a method of using a browser feature, according to an exemplary embodiment;

FIG. 8 is a flowchart of a method of using an audio feature, according to another exemplary embodiment;

FIG. 9 is a flowchart of a method of using a DTV as a display device, according to another exemplary embodiment;

FIG. 10 is a flowchart of a method of using a broadcasting feature, according to another exemplary embodiment;

FIG. 11 is a flowchart of a method of using a DTV as a modem, according to another exemplary embodiment;

FIG. 12 is a flowchart of a method of using a DTV in a normal mode, according to another exemplary embodiment;

FIG. 13 is a flowchart of a method of using a video recording feature, according to another exemplary embodiment;

FIG. 14 is a flowchart of a method of using a speaker feature, according to another exemplary embodiment; and

FIG. 15 is a flowchart of a method of using a multi-mode, according to another exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. In the disclosure, the terms indicating a relationship, such as ‘first’ and ‘second’, can be used to classify a certain entity from another entity without unnecessarily suggesting an actual relationship or order between the entities. As used herein, the term “and/or” includes any and all combinations of one or more of the associated listed items.

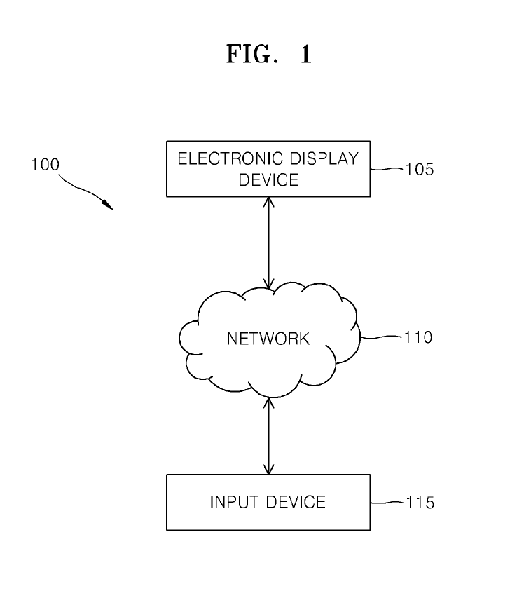

FIG. 1 is a block diagram of an environment 100 to which an exemplary embodiment is applied, and various exemplary embodiments may be implemented according to the environment 100. The environment 100 may include an electronic display device 105, a network 110, and an input device 115. The electronic display device (hereinafter, referred to as “display device”) 105 is connected to the input device 115 over the network 110. Examples of the electronic display device 105 may include a digital television (DTV), a mobile device, a laptop computer, a tablet device, a personal digital assistance (PDA), a smartphone, and a home theater system but are not limited thereto.

Examples of the network 110 may include infrared communication, a local area network (LAN), a wide area network (WAN), and a wireless network but are not limited thereto.

Examples of the input device 115 may include a remote control, a smart phone, a game pad, and a tablet but are not limited thereto. In addition, the electronic display device 105 may include display panel buttons and a keypad as an input device.

A user may control the electronic display device 105 through the input device 115.

According to an exemplary embodiment, the user may select a feature button option provided by the input device 115 while the electronic display device 105 is in a stand-by mode. The electronic display device 105 may then receive the user selection input associated with a feature of the electronic display device 105. Thereafter, one or more modules that may be provided by the electronic display device 105, which are associated with the feature selected by the user, may be initialized. The initialization may include activation of the one or more modules such that the user may use the modules. Thereafter, the user may use the feature in the electronic display device 105. As another example, the electronic display device 105 may be implemented so as to activate not only the one or more modules associated with the feature selected by the user but also a display. The display of the electronic display device 105 usually functions to display video content, but because the display also normally functions as an interface between the electronic display device 105 and the user, the display may be activated as a user interface.

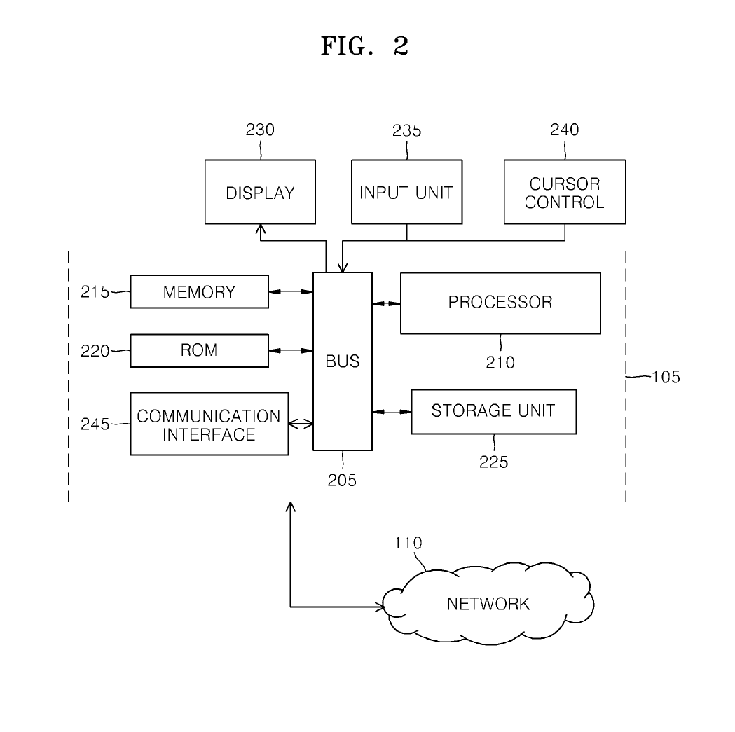

The electronic display device 105 including a plurality of components will now be described in detail with reference to FIG. 2.

FIG. 2 is a block diagram of an electronic display device (e.g., the display device 105) according to an exemplary embodiment.

The electronic display device 105 may include a bus 205, or another communication mechanism for communicating information, and a processor 210 which is connected to the bus 205 and processes the information. The electronic display device 105 may also include a memory 215 (e.g., a random access memory (RAM) or another dynamic storage device) connected to the bus 205, and the memory 215 may store instructions to be executed by the processor 210 as well as the information. The memory 215 may also be used to store temporary variables or other intermediate information while the processor 210 executes the instructions. The electronic display device 105 also includes a read only memory (ROM) 220 or another static storage device which is connected to the bus 205 that may store instructions and static information for the processor 210. A storage unit 225 (e.g., a magnetic disc, an optical disc, or a solid state drive) may also be provided and connected to the bus 205 to store information.

The electronic display device 105 may be coupled to a display 230 (e.g., a cathode-ray tube (CRT), a light-emitting diode (LED) display, or a liquid crystal display (LCD)) via the bus 205 to display data. An input unit 235, that may include alphanumeric keys and other keys, is connected to the bus 205 to transfer information and a command selection to the processor 210. Another type of a user input device that may be included is a cursor controller 240 (e.g., a mouse, a trackball, or a cursor direction key) for transferring direction information and a command selection to the processor 210 and controlling a cursor motion on the display 230.

Various exemplary embodiments are associated with the use of the electronic display device 105 to implement the technology described in the specification. According to one or more exemplary embodiments, the electronic display device 105 may carry out the technology in response to the processor 210 for executing the instructions included in the memory 215. The instructions may be loaded into the memory 215 from another machine-readable medium (e.g., the storage unit 225). By the execution of the instructions included in the memory 215, the processor 210 may perform a process operation described in the specification.

According to one or more exemplary embodiments, the processor 210 may include one or more processing units for performing one or more functions of the processor 210. The processing units are hardware circuits that may replace software instructions, or a combination therewith that are configured to perform a certain function.

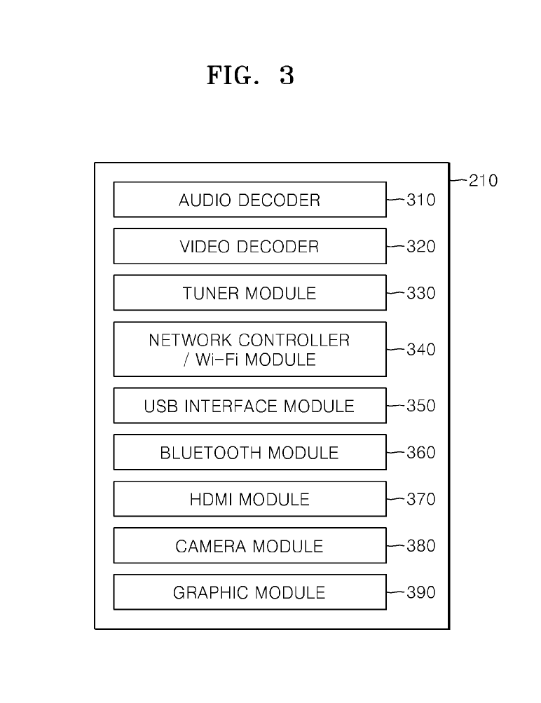

According to one or more exemplary embodiments, the electronic display device 105 may extend so as to include a plurality of modules, and the plurality of modules may be provided in the processor 210 as shown in FIG. 3.

FIG. 3 is a block diagram of a processor (e.g. processor 210) in an electronic display device (e.g. electronic display device 105 of FIG. 2), according to an exemplary embodiment.

Referring to FIG. 3, the processor 210 may include at least one or more of an audio decoder 310 for decoding audio data, a video decoder 320 for decoding video data, a tuner module 330, a network controller/Wi-Fi module 340, a USB interface module 350, a Bluetooth module 360 capable of performing Bluetooth communication, a high-definition multimedia interface (HDMI) module 370, a camera module 380 capable of capturing an image, and a graphic module 390 capable of processing graphic data but is not limited thereto. Although FIG. 3 shows that the plurality of modules are included in the processor 210, other embodiments are not limited thereto, and some or all of the plurality of modules may be provided outside the processor 210.

According to an exemplary embodiment, the plurality of modules correspond to respective features of the electronic display device 105. An electronic display device, such as a TV, may include a plurality of modules as shown in FIG. 3 therein, and all of the plurality of modules may be configured such that they are supposed to be initialized when the TV is booted, and thus, a booting time may be long, and corresponding power is consumed by all the modules. However, when the user desires to use only one, or a small number of, function modules among the plurality of modules, it may be an excessive expenditure of both time and energy spent to initialize all of the plurality of modules. Therefore, according to an exemplary embodiment, by initializing only the modules corresponding to a feature selected by the user, an initializing time may be reduced, and power consumption by all modules may be prevented.

The term “machine-readable medium” used in the specification indicates all media participating in providing data so that a machine performs a certain function. According to an exemplary embodiment, which is implemented by using the electronic display device 105, various machine-readable media may participate in execution by providing instructions to the processor 210. The machine-readable medium may be a volatile or nonvolatile storage medium. The volatile storage medium includes, for example, a dynamic memory, such as the memory 215. The nonvolatile storage medium includes, for example, an optical or magnetic disc, such as the storage unit 225. It is recommended that all these media are tangible so that a physical mechanism which reads instructions into a machine detects the instructions.

Typical types of the machine-readable medium include, for example, magnetic media, such as, floppy disks, flexible disks, hard disks, magnetic tapes, and the like, optical media, such as CD-ROM and the like, physical media, such as punchcards, papertapes, and other media having a pattern of holes, and memory chips and cartridges, such as RAM, programmable ROM (PROM), erasable PROM (EPROM), FLASH-EPROM, and the like.

According to an exemplary embodiment, the machine-readable medium may be a transmission medium including a coaxial cable, a copper wire, and an optical fiber or a transmission medium including a wire which includes the bus 205. The transmission medium may have a form of sound or optical wave, such as a radio wave or a wave generated during infrared data communication. Examples of the machine-readable medium may include a carrier wave described below and an arbitrary medium which is read by a display device but are not limited thereto. For example, instructions may be stored in a magnetic disc of a remote computer at first. The remote computer may load the instructions into a dynamic memory therein and transmit the instructions over a telephone line by using a modem. A local modem of the electronic display device 105 may receive data over a telephone line and use an infrared transmitter for converting the data into an infrared signal. An infrared detector may receive the data carried on the infrared signal, and a proper circuit may provide the data to the bus 205. The bus 205 transfers the data to the memory 215, and the processor 210 searches for the instructions from the memory 215 and executes the instructions. The instructions received by the memory 215 may be selectively stored in the storage unit 225 before or after execution by the processor 210. It is recommended that all these media are necessarily tangible so that the instructions stored in the media are detected by a physical mechanism for reading the instructions into a machine.

Referring back to FIG. 2, the electronic display device 105 may also includes a communication interface 245 connected to the bus 205. The communication interface 245 may connect the display device 105 and the input device 115 through the network 110 and may provide bidirectional data communication. For example, the communication interface 245 may be an integrated services digital network (ISDN) card or modem for providing a data communication connection to a corresponding type of a telephone line. As another example, the communication interface 245 may be a LAN card for providing a data communication connection to a compatible LAN. In all these implementation examples, the communication interface 245 transmits and receives an electrical signal, an electromagnetic signal, or an optical signal, and these signals carry a digital data stream indicating various types of information.

The processor 210 of the electronic display device 105 may operate so as to receive a user selection input from the user of the electronic display device 105. The user selection input is associated with a feature of the electronic display device 105. The processor 210 which has received the user selection input initializes one or more modules in the electronic display device 105 which are associated with the feature. The processor 210 also allows the user to use the feature in the electronic display device 105.

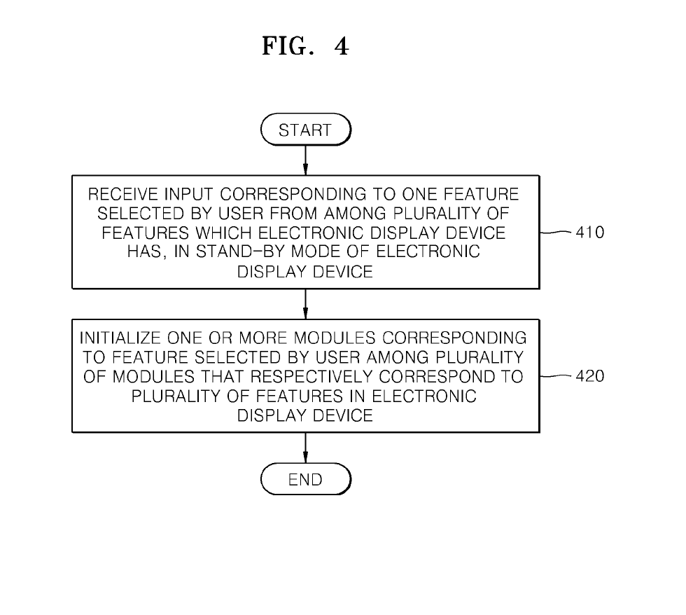

FIG. 4 is a flowchart of a method of operating an electronic display device, according to an exemplary embodiment.

In operation 410, the electronic display device (e.g., the electronic display device 105) receives an input corresponding to one feature selected by a user from among a plurality of features which the electronic display device has, in a stand-by mode of the electronic display device. The stand-by mode indicates a state where the electronic display device just waits until the electronic display device is activated by input devices included in a remote control or a display device without performing main modules or main functions in the electronic display device. The input selected by the user may be associated with a feature of the electronic display device. Examples of a plurality of features which the electronic display device has include a device browser feature, an audio feature, a video recording feature, a speaker feature, and the like but are not limited thereto. The plurality of features which the electronic display device has are provided in a form of modules for realizing the features or functions of the features in the electronic display device. For example, as shown in FIG. 3, the processor 210 may include modules respectively corresponding to the plurality of features.

According to one or more exemplary embodiments, the user provides a user selection input by using an input device (e.g., the input device 115) of the electronic display device. The input device may be an individual device or may be included in the electronic display device.

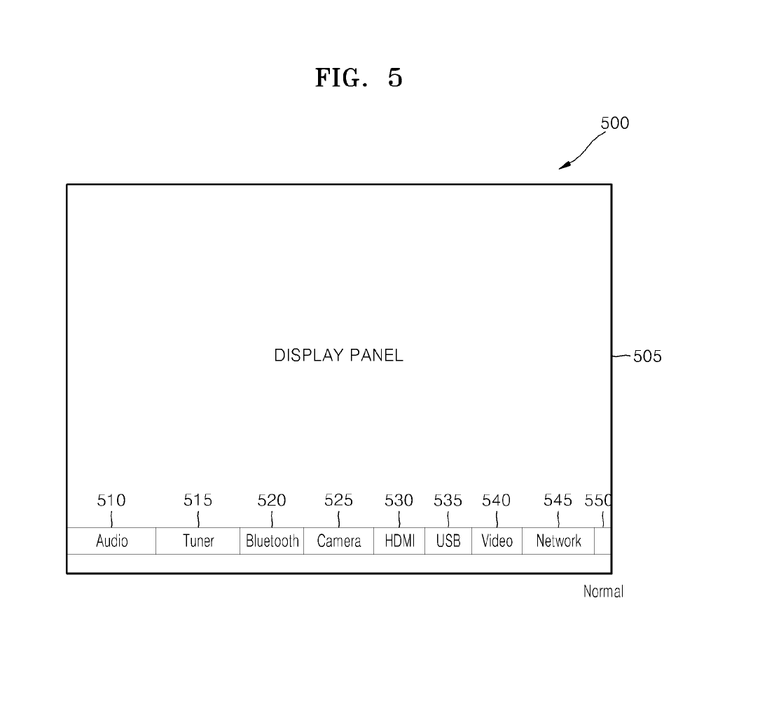

FIG. 5 illustrates a form in which an input device is provided in an electronic display device, according to an exemplary embodiment.

Referring to FIG. 5, a display panel 505 constituting a display 500 includes a plurality of panel buttons respectively corresponding to a plurality of features. The plurality of panel buttons include an audio feature button 510, a tuner feature button 515, a Bluetooth feature button 520, a camera feature button 525, an HDMI feature button 530, a USB feature button 535, a video feature button 540, a network feature button 545, and a normal feature button 550. Each feature button is provided to use a feature of the electronic display device, corresponds to a module having each feature in the electronic display device, and activates the module having the feature to be initialized when selected. A plurality of feature buttons are not limited thereto, and some feature buttons may be further added to or removed from the feature buttons shown in FIG. 5. The user selects a feature button associated with a feature, and the selection is transmitted to the electronic display device as a user selection input.

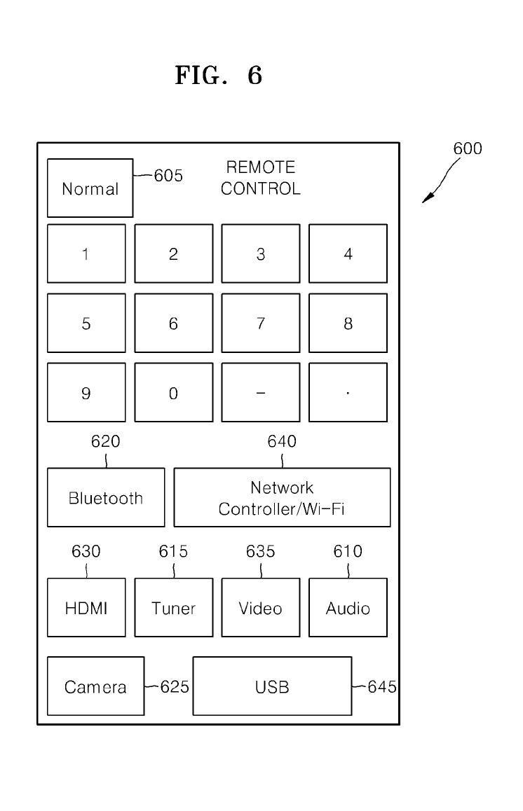

FIG. 6 illustrates a form in which feature buttons are provided in an input device that is separated from an electronic display device, according to another exemplary embodiment.

Referring to FIG. 6, a remote control 600 may include a normal feature button 605, an audio feature button 610, a tuner feature button 615, a Bluetooth feature button 620, a camera feature button 625, an HDMI feature button 630, a video feature button 635, a network controller/Wi-Fi feature button 640, and a USB feature button 645. Each feature button is provided to use a feature of the electronic display device, corresponds to a module having each feature in the electronic display device, and activates the module having the feature to be initialized. A plurality of feature buttons are not limited thereto, and some feature buttons may be further added to or removed from the feature buttons shown in FIG. 6. The user selects a feature button associated with a feature, and the selection is transmitted to the electronic display device as a user selection input.

Referring back to FIG. 4, in operation 420, one or more modules corresponding to the feature selected by the user are initialized among a plurality of modules that respectively correspond to the plurality of features in the electronic display device. That is, when the user selects, for example, a video feature button in a remote control, the electronic display device receives the user selection input and initializes one or more modules corresponding to a video feature but does not have to initialize the other modules, and thus, an initialization time may be reduced, and power consumption may be prevented. In addition, the user may still use a selected feature of the electronic display device.

The method may be configured so that the electronic display device, which has received the user selection input, activates a display of the electronic display device besides the initialization of the one or modules corresponding to the feature selected by the user. Because a display module usually acts as a user interface between the user and the electronic display device, the method may be configured to activate the display as a user interface for using the one or modules corresponding to the feature selected by the user.

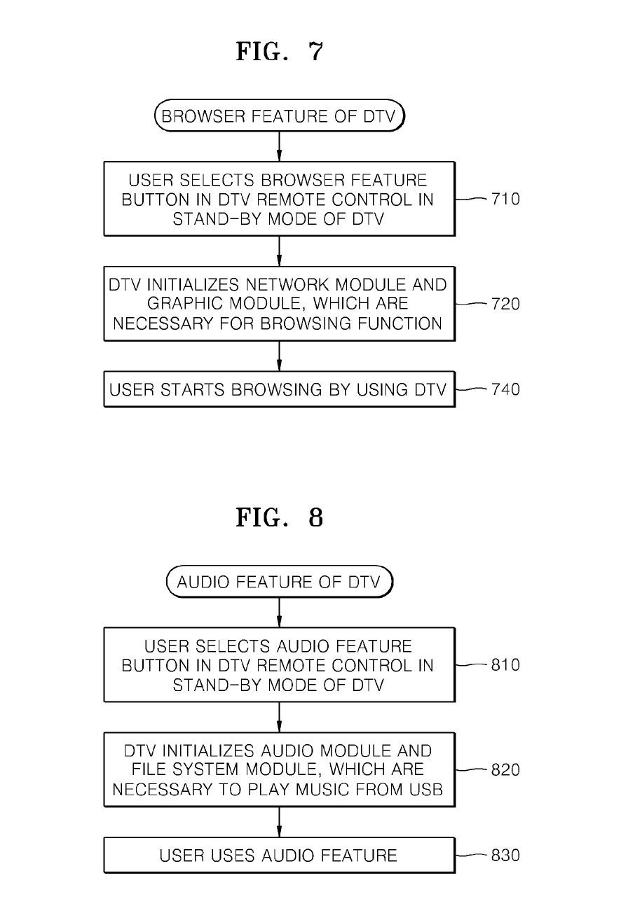

FIG. 7 is a flowchart of a method of using a browser feature, according to an exemplary embodiment.

In operation 710, a user who desires to use the browser feature, which is in in a stand-by mode of a DTV, selects a browser feature button using a DTV remote control.

In operation 720, the DTV initializes only a network module and a graphic module, which may be needed for a browsing function, corresponding to the browser feature button.

In operation 740, the user starts browsing by using the DTV.

FIG. 8 is a flowchart of a method of using an audio feature, according to another exemplary embodiment.

In operation 810, a user who desires to use the audio feature, which is in a stand-by mode of a DTV, selects an audio feature button using a DTV remote control.

In operation 820, the DTV initializes only an audio module and a file system module, which may be needed to play music from a USB, in response to the selection of the audio feature button. The other modules (e.g., a tuner module and a network module) remain in a non-initialized state.

In operation 830, the user uses the audio feature.

According to one or more exemplary embodiments, the audio feature may extend so as to include a frequency modulation (FM) feature. The DTV may initialize only the audio module, the file system module, and an FM tuner module for the FM feature.

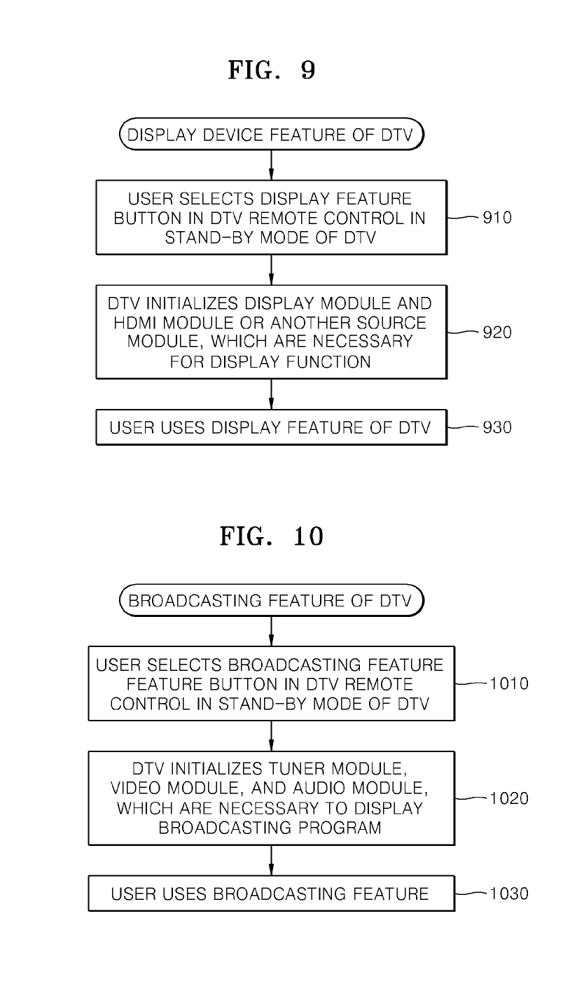

FIG. 9 is a flowchart of a method of using a DTV as a display device, according to another exemplary embodiment.

In operation 910, a user who desires to use the DTV as the display device selects a display feature button in a DTV remote control, where the associated modules are in a stand-by mode in the DTV.

In operation 920, the DTV initializes only a display module and an HDMI module or another source module, which may be needed for a display function, corresponding to the display feature button.

In operation 930, the user uses the display feature of the DTV.

FIG. 10 is a flowchart of a method of using a broadcasting feature, according to another exemplary embodiment.

In operation 1010, a user who desires to use the broadcasting feature that is in a stand-by mode of a DTV selects a broadcasting feature button in a DTV remote control.

In operation 1020, the DTV initializes only a tuner module, a video module, and an audio module, which may be needed to display a broadcasting program, corresponding to the broadcasting feature button.

In operation 1030, the user uses the broadcasting feature of the DTV.

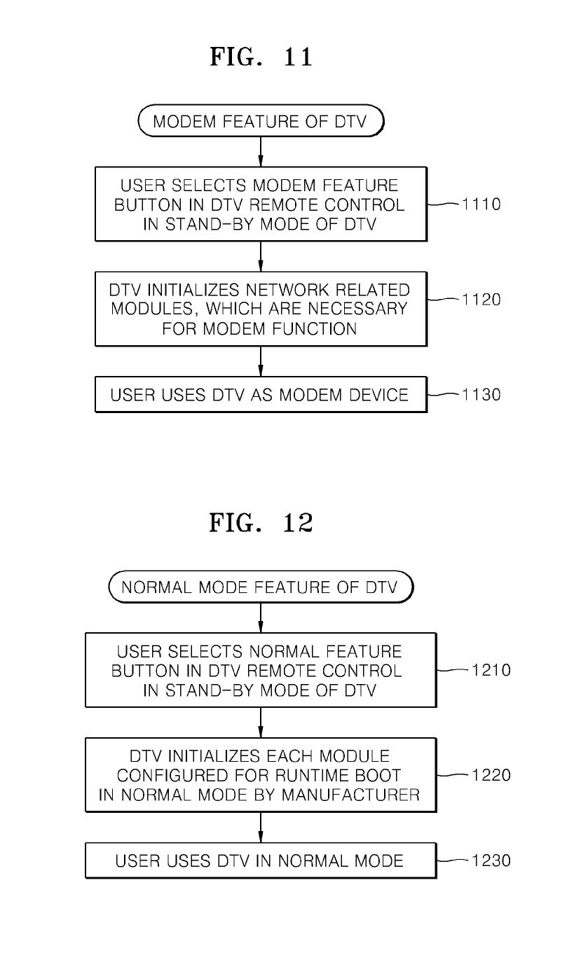

FIG. 11 is a flowchart of a method of using a DTV as a modem, according to another exemplary embodiment.

In operation 1110, a user who desires to use the DTV as a modem device selects a modem feature button in a DTV remote control, where the modem feature is in a stand-by mode of the DTV.

In operation 1120, the DTV initializes only network related modules, which may be needed for a modem function, corresponding to the modem feature button.

In operation 1130, the user uses the DTV as a modem device.

FIG. 12 is a flowchart of a method of using a DTV in a normal mode, according to another exemplary embodiment.

In operation 1210, a user who desires to use the DTV in the normal mode selects a normal feature button in a DTV remote control, where the normal feature and any associated modules are in a stand-by mode of the DTV.

In operation 1220, the DTV initializes each module configured for a runtime boot in the normal mode by a manufacturer.

In operation 1230, the user uses the DTV in the normal mode.

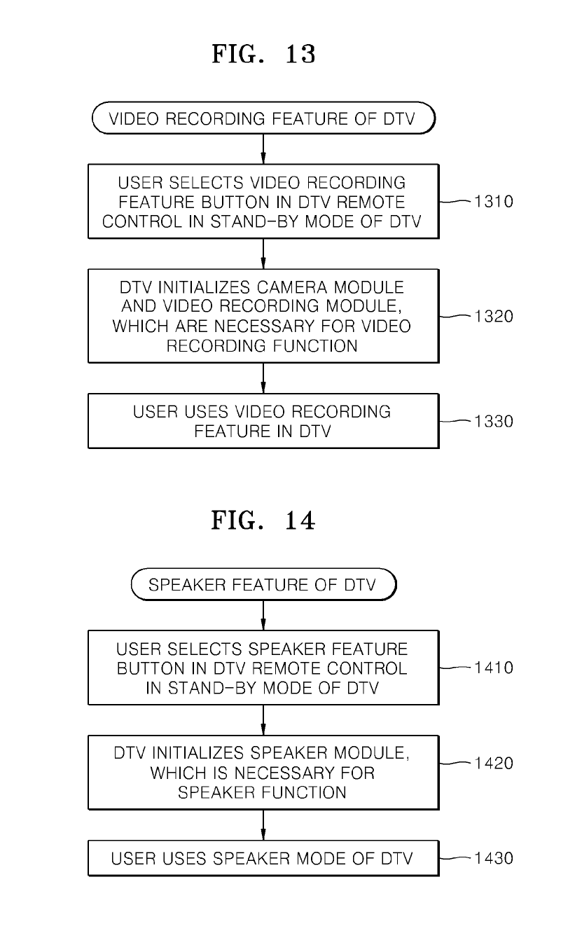

FIG. 13 is a flowchart of a method of using a video recording feature, according to another exemplary embodiment.

In operation 1310, a user who desires to use the video recording feature in a DTV selects a video recording feature button in a DTV remote control, where the video recording feature and any associated modules are in a stand-by mode of the DTV.

In operation 1320, the DTV initializes only a camera module and a video recording module, which may be needed for a video recording function, corresponding to the video recording feature button.

In operation 1230, the user uses the video recording feature in the DTV.

FIG. 14 is a flowchart of a method of using a speaker feature, according to another exemplary embodiment.

In operation 1410, a user who desires to use the speaker feature in a DTV selects a speaker feature button in a DTV remote control, where the speaker feature and associated modules are in a stand-by mode of the DTV.

In operation 1420, the DTV initializes only a speaker module, which may be needed for a speaker function, corresponding to the speaker feature button.

In operation 1430, the user uses a speaker mode of the DTV.

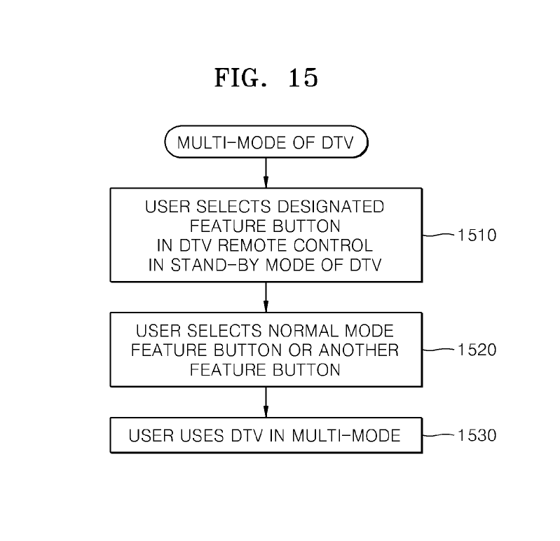

FIG. 15 is a flowchart of a method of using a multi-mode, according to another exemplary embodiment.

In operation 1510, a user who desires to use the multi-mode while in a stand-by mode of a DTV selects a designated feature button in a DTV remote control. According to an exemplary embodiment, a browser mode button and an audio feature button may be pressed. According to one or more exemplary embodiments, a multi-mode feature is included in a DTV. Accordingly, a user may press a multi-mode feature button for different modes of the DTV.

In operation 1520, the user accesses another mode of the DTV by selecting a normal mode feature button or another feature button.

In operation 1530, the user uses the DTV in the multi-mode.

As described above, according to the one or more of the above exemplary embodiments, an electronic display device may be used as a multi-mode device. Therefore, a user may quickly access an application without fully booting a DTV and without passing through all menu layers. Because only related modules are initialized one by one, the usage of a central processing unit (CPU) is also reduced. The performance of the DTV is improved due to a small CPU load and a small number of applications executed in the background. In addition, because small power is used for modules, an eco-friendly environment is achieved.

One or more exemplary embodiments can also be embodied as computer-readable codes on a computer-readable recording medium. The computer-readable recording medium is any data storage device that can store data which can be thereafter read by a computer system. Examples of the computer-readable recording medium include ROM, RAM, CD-ROMs, magnetic tapes, floppy disks, optical data storage devices, and the like. The computer-readable recording medium can also be distributed over network coupled computer systems so that the computer-readable code is stored and executed in a distributed fashion.

In addition, other exemplary embodiments can also be implemented through computer-readable code/instructions in/on a medium, e.g., a computer-readable medium, to control at least one processing element to implement any above described exemplary embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of operating an electronic display device, the method comprising:
configuring a plurality of modules of the electronic display device into a stand-by mode;
receiving an input corresponding to a feature selected from among a plurality of features of the electronic display device; and
initializing, from among the plurality of modules, one or more modules that correspond to the feature selected of the electronic display device,
wherein one or more of the plurality of modules respectively correspond to one or more of the plurality of features.

2. The method of claim 1, further comprising:
activating a display of the electronic display device in response to the input being received.

3. The method of claim 1, further comprising:
providing, at the electronic display device, a plurality of buttons respectively corresponding to the plurality of features,
wherein the plurality of buttons are configured to receive the input.

4. The method of claim 1, further comprising:
providing, to an input device that is separate from the electronic display device, a plurality of buttons respectively corresponding to the plurality of features,
wherein the plurality of buttons are configured to receive the input.

5. An electronic display device comprising:
a display;
a communication device configured to communicate with an input device;
a memory configured to store instructions; and
a processor configured to:
access the instructions stored in the memory,
receive an input corresponding to a feature selected from among a plurality of features of the electronic display device, while the electronic display device is in a stand-by mode in response to the processor accessing the instructions, and
initialize, from among a plurality of modules, one or more modules that correspond to the feature selected of the electronic display device,
wherein one or more of the plurality of modules respectively correspond to one or more of the plurality of features.

6. The electronic display device of claim 5, wherein the processor activates the display of the electronic display device in response to the input being received and to accessing the instructions.

7. The electronic display device of claim 5, wherein a plurality of buttons respectively corresponding to the plurality of features are provided to the electronic display device, wherein the plurality of buttons are configured to receive the input.

8. The electronic display device of claim 5, further comprising:
an input device that provides a plurality of buttons respectively corresponding to the plurality of features,
wherein the plurality of buttons are configured to receive the input.

9. A non-transitory computer-readable storage medium having stored therein program instructions, that when executed by a computer, perform a method of operating an electronic display device, the method comprising:
configuring a plurality of modules of the electronic display device into a stand-by mode;
receiving an input corresponding to a feature selected from among a plurality of features of the electronic display device; and
initializing, from among the plurality of modules, one or more modules that correspond to the feature selected of the electronic display device,
wherein one or more of the plurality of modules respectively correspond to one or more of the plurality of features.

10. A display system comprising:
an input device comprising:
at least one input button configured to receive an input from a user,
wherein the input device is configured to transmit the input;
an electronic display device comprising:
a communication interface configured to receive, from the input device,
the input that corresponds to a feature of the electronic display device;
a processor configured to activate a module corresponding to the feature from among a plurality of modules that are in a stand-by mode; and
a display configured to display a graphic corresponding to the input, selected feature, and activated module.

11. A method of controlling a display, the method comprising:
selecting a feature from a plurality of features of a display device; and
activating a module from a plurality of modules of the display device, wherein the plurality of modules are in a stand-by mode,
wherein the activated module corresponds to the selected feature, and
wherein remaining modules of the plurality of modules unrelated to the feature remain in the stand-by mode.
